(19) United States
(12) Patent Application Publication
(10) Pub. No.: US 2008/0033698 A1
(43) Pub. Date: Feb. 7, 2008

(54) LEAKAGE LOCATION METHODS

(75) Inventor: Raleigh Benton Stelle, Indianapolis, IN (US)

Correspondence Address: BARNES & THORNBURG LLP, 11 SOUTH MERIDIAN, INDIANAPOLIS, IN, 46204, US

(73) Assignee: TRILITHIC, INC., Indianapolis, IN (US)

(21) Appl. No.: 11/742,184

(22) Filed: Apr. 30, 2007

Related U.S. Application Data
(60) Provisional application No. 60/836,036, filed on Aug. 7, 2006.

(51) Int. Cl. G06F 15/00

(52) U.S. Cl. 702/189

(57) ABSTRACT

A method of determining the location and/or amplitude of a leakage signal from a network includes measuring at various times and locations leakage believed to be associated with the leakage signal and constructing a data base of leakages and associated locations. Leakage signal values are selected from the data base. Each of the selected leakage signal values is multiplied by a locus of points on which a leakage signal associated with that respective signal strength may be assumed to reside in order to develop a number of relationships among leakage signal strength, leakage and location. A first pair of these relationships among leakage signal strength, leakage and location is solved for a first locus of points common to the first pair. A second pair of these relationships among leakage signal strength, leakage and location is solved for a second locus of points common to the second pair. The first and second loci are projected onto a common surface, and an intersection of the thus-projected first and second loci on the common surface is determined.

### CROSS-REFERENCE TO RELATED APPLICATIONS

This application claims the benefit under 35 U.S.C. § 119(e) of the Aug. 7, 2006 filing date of U.S. S. N. 60/836,036, titled “Leakage Location Method,” the complete disclosure of which is incorporated herein by reference.

### BACKGROUND OF THE INVENTION

This invention relates to methods for determining the location of leakage from, for example, CATV cables, taps, fittings, drops and other CATV plant facilities.

### DISCLOSURE OF THE INVENTION

A method of determining the location of a leakage signal from a network includes measuring at various times and locations leakage believed to be associated with the leakage signal and constructing a data base of leakages and associated locations. Leakage signal values are selected from the data base. Each of the selected leakage signal values is multiplied by a locus of points on which a leakage signal associated with that respective signal strength may be assumed to reside in order to develop a number of relationships among leakage signal strength, leakage and location. A first pair of these relationships among leakage signal strength, leakage and location is solved for a first locus of points common to the first pair. A second pair of these relationships among leakage signal strength, leakage and location is solved for a second locus of points common to the second pair. The first and second loci are projected onto a common surface, and an intersection of the thus-projected first and second loci on the common surface is determined.

Further illustratively, the method includes determining the strength of the leakage signal by substituting the intersection of the first and second loci on the common surface back into a selected relationship among leakage signal strength, leakage and location and solving for the strength of the leakage signal.

Illustratively, solving a first pair of the relationships among leakage signal strength, leakage and location for a first locus of common points to the first pair and solving a second pair of the relationships among leakage signal strength, leakage and location for a second locus of common points to the second pair together comprise selecting a location about which the solutions are to be normalized and solving the first and second pairs of the relationships about the location about which the solutions are to be normalized.

Illustratively, solving a first pair of the relationships among leakage signal strength, leakage and location for a first locus of common points to the first pair and solving a second pair of the relationships among leakage signal strength, leakage and location for a second locus of common points to the second pair, and projecting the first and second loci onto a common surface together comprise converting an angular distance into a linear distance.

Illustratively, converting an angular distance into a linear distance comprises using a table to convert an angular distance into a linear distance.

Alternatively or additionally illustratively, converting an angular distance into a linear distance comprises calculating a linear distance from an angular distance.

### BRIEF DESCRIPTION OF THE DRAWINGS

The invention may best be understood by referring to the following detailed description and accompanying drawings which illustrate the invention. In the drawings:

FIG. 1 illustrates a perspective view useful in understanding the present invention;

FIG. 2 illustrates a graph useful in understanding the present invention;

FIG. 3 illustrates a plan view useful in understanding the present invention; and,

FIG. 4 illustrates a graph useful in understanding the present invention.

### DETAILED DESCRIPTIONS OF ILLUSTRATIVE EMBODIMENTS

Leakage measurements of signal from a CATV plant including, for example, CATV cables, taps, fittings, drops and other CATV plant facilities, may readily be made by, for example, CATV system employees during their conduct of their daily activities. Such leakage measurements, stored in leakage measurement equipment of the type described in, for example, Trilithic Seeker GPS leakage management system available from Trilithic, Inc., 9710 Park Davis Drive, Indianapolis, Ind. 46235, the disclosure of which is hereby incorporated herein by reference, are uploaded from such CATV system employee equipment into a server at a CATV headend, for example, at the ends of the employees' shifts. Such CATV system employees' daily activities may include, for example, visiting subscriber sites to conduct maintenance and repairs, driving the CATV system to log leakage levels, and so on.

This activity can provide a database of cable system leakage strengths measured at multiple locations, which can be determined with considerable accuracy by associating with each such measurement a location, such as a latitude and longitude provided by a Global Positioning System (GPS) device. Such data sets might look like the following table when sorted in order of descending detected leakage level and eliminating leakage levels below a certain threshold (10 μV in this example):

| | | Leakage (μV or |
|---|---|---|
| Latitude | Longitude | other suitable dimension) |
| 39.502145° | −85.594748° | 26 |
| 39.502003° | −85.594720° | 23 |
| 39.502089° | −85.594722° | 21 |
| 39.502066° | −85.594746° | 20 |
| 39.502131° | −85.595057° | 19 |
| 39.502223° | −85.594751° | 16 |
| 39.502210° | −85.595003° | 16 |
| 39.502188° | −85.595096° | 16 |
| 39.502183° | −85.595142° | 16 |
| 39.502208° | −85.594939° | 15 |
| 39.502011° | −85.594726° | 14 |
| 39.502145° | −85.594750° | 14 |
| 39.502303° | −85.594753° | 13 |
| 39.502054° | −85.594725° | 13 |
| 39.502196° | −85.595049° | 13 |
| 39.502172° | −85.595028° | 13 |
| 39.502095° | −85.594724° | 12 |
| 39.502094° | −85.595056° | 12 |
| 39.502182° | −85.595002° | 12 |
| 39.502194° | −85.594972° | 12 |
| 39.502098° | −85.594727° | 11 |
| 39.502175° | −85.594723° | 11 |
| 39.502226° | −85.594959° | 11 |
| 39.502226° | −85.594959° | 11 |
| 39.502181° | −85.595188° | 11 |
| 39.502067° | −85.595321° | 11 |
| 39.502062° | −85.595106° | 11 |
| 39.502063° | −85.594713° | 11 |
| 39.502175° | −85.594727° | 10 |
| 39.502114° | −85.595058° | 10 |
| 39.502146° | −85.595055° | 10 |
| 39.502160° | −85.595045° | 10 |

Using this data, which, again, is typically extracted from a larger data set accumulated over days, weeks, months, etc., of data collection and then sorted and limited by differences of latitude and longitude from the largest system leak in the list, the location and magnitude of a leakage source giving rise to this data may be isolated. The method employs leakage signal strength versus distance considerations.

Leakage detectors and their associated antenna systems are calibrated to be accurate at a fixed distance from a radiation source, such as the source of a leak. It is not uncommon in the CATV industry to use three meters as a measurement standard. So, in the case of a 10 μV/m leak, for example, which is calibrated to be accurate at a distance of three meters from the leakage source, a leak indicated as having a strength of 10 μV/m could reside anywhere on a radius three meters from the leakage antenna. If the leakage strength were doubled to 20 μV/m and the antenna were six meters from the source, the leakage detecting instrument would still indicate a leakage signal strength of 10 μV/m. So, for a given measured 10 μV/m leak, one can envision an inverted cone of potential leakage sources and leakage signal strengths which would all give rise to the same 10 μV/m reading at the location of the leakage detecting antenna, with the x and y dimensions of the cone being the longitude and latitude of the cone's surface at various points and z being the indicated strength of the leakage signal. In this example, there is a three meter circle of potential 10 μV/m leaks around the leakage antenna, a six meter circle of 20 μV/m leaks, a nine meter circle of 30 μV/m leaks, and so on in circles of increasing radius at increasing heights (z values) corresponding to increasing leakage signal strength. If one imagines the location for this 10 μV/m reading on the leakage detector to be defined by latitude and longitude coordinates with x mapping to longitude, y mapping to latitude and z mapping to leakage level, then the increasing circles around the current location of the leakage detector can be visualized as a cone standing on its apex. Every leak stored in the database can be represented in this way with its apex at the GPS-determined position of the antenna at the time the particular leakage signal strength is measured. The equation for each leakage cone may then be written as:

z=L₁sqrt((x−x₁)²+(y−y₁)²)

where sqrt is the square root operator;

### L₁=the measured leakage value at a calibrated distance (three meters in the following examples);

x₁=the longitude of the measured leak; and,
y₁=the latitude of the measured leak.

For purposes of this discussion, zₙ will indicate the nth detected leak. Using (arbitrarily) the first four rows of the above data set, the following four equations are obtained:

z₁=L₁sqrt((x−x₁)²+(y−y₁)²);

z₂=L₂sqrt((x−x₂)²+(y−y₂)²);

z₃=L₃sqrt((x−x₃)²+(y−y₃)²); and,

z₄=L₄sqrt((x−x₄)²+(y−y₄)²),

where xₙ, yₙ and zₙ are the longitude, latitude and leakage signal strength displayed in the nth row of the above table, and

L₁=26/3 μV/m;

L₂=23/3 μV/m;

L₃=21/3 μV/m; and

L₄=20/3 μV/m,

using the above convention, leakage signal strength detected at three meters from the leakage antenna. From the above table:

x₁=−85.594748°;

x₂=−85.594720°;

x₃=−85.594722°;

x₄=−85.594746°;

y₁=39.502145°;

y₂=39.502003°;

y₃=39.502089°; and,

y₄=39.502066°.

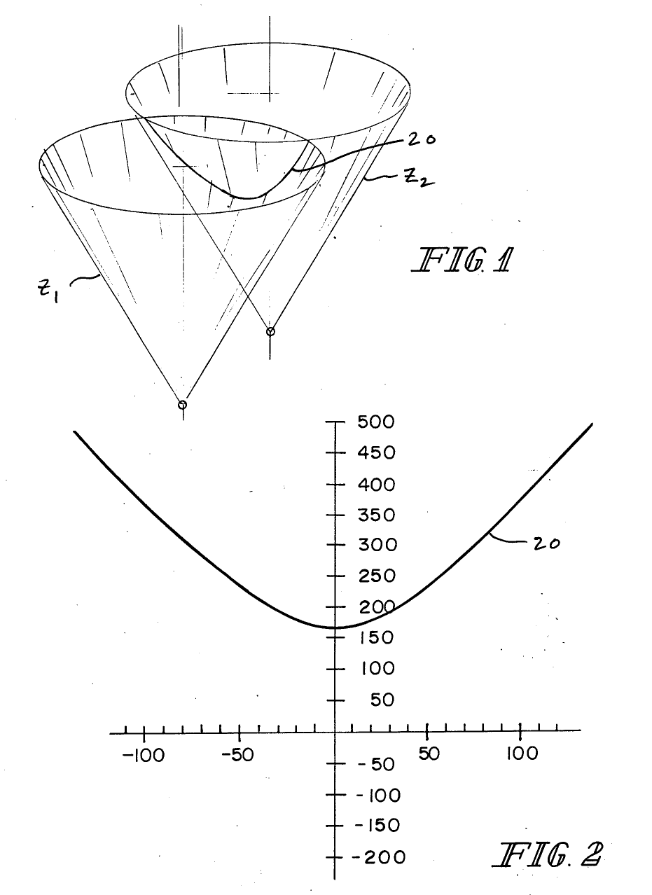

If the intersection of two adjacent inverted cones, for example, z₁ and z₂, is plotted, the intersection is an arc 20, as illustrated in FIG. 1. An enlarged, two dimensional illustration of this intersection is illustrated in FIG. 2. If the intersection of another two adjacent inverted cones, for example, z₃ and z₄, is then plotted, another similar intersection is formed. Look down from above on the two arcs formed by the intersections of pairs of the four data points, a point of intersection is illustrated in FIG. 3.

Again, looking into any of these cones z₁, z₂, z₃, z₄ from above, at any given leakage signal strength (that is, any vertical elevation), it may be visualized as a circle. In FIG. 3, circle 30 illustrates the downward view along the z axis of z₁. Circle 32 illustrates the downward view along the z axis of z₂. Continuing to look down from above, then, the intersection of these two inverted cones is the arc 20. Circle 36 illustrates the downward view along the z axis of z₃. Circle 40 illustrates the downward view along the z axis of z₄. The intersection of the cones z₃ and z₄ is the arc 42. Arcs 20, 42 projected downward intersect at a point 44 in latitude and longitude, which is the calculated location of the leak which is the source of this data.

Now that a specific x and y, that is, longitude and latitude, of interest have been identified, those values can be substituted back into any one of the equations above for z₁, z₂, z₃ or z₄ to calculate the strength of the leak at that x and y. For purposes of illustration, the equation for z₁ will be used to demonstrate this. First, the differences (y−y₁) and (x−x₁) in latitude and longitude need to be converted into meters. Tables stored in instruments such as the above-mentioned server at a CATV headend, a separate computer associated therewith, or calculators provided in such instruments, or some combination of these, are used for these conversions, since such conversions depend upon the latitudes and longitudes which are the subjects of the calculations, that is, upon the curvature of the earth's surface at the latitudes and longitudes of interest. See, for example, http://www.csgnetwork.com/degreelenllavcalc.html, for such a calculator.

z₁=(26/3)sqrt((x+85.594748°)²+(y−39.502145°)²);

z₂=(23/3)sqrt((x+85.594720°)²+(y−39.502003°)²);

z₃=(21/3)sqrt((x+85.594722°)²+(y−39.502089°)²); and,

z₄=(20/3)sqrt((x+85.594746°)²+(y−39.502066°)²).

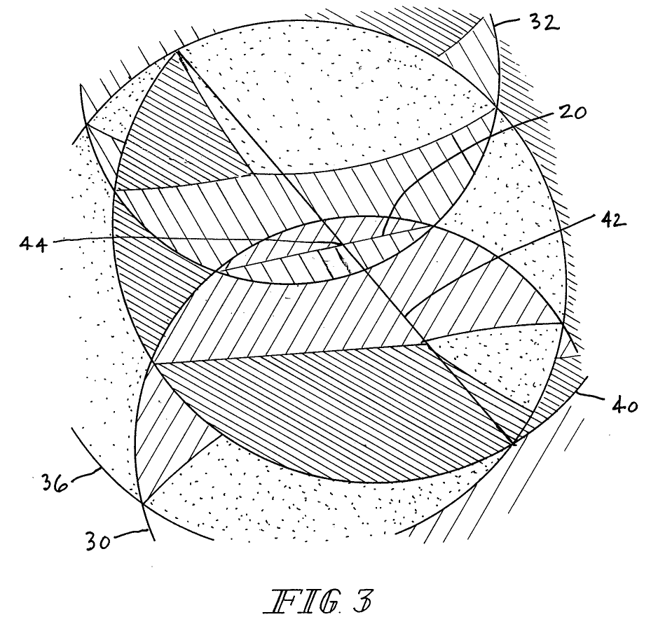

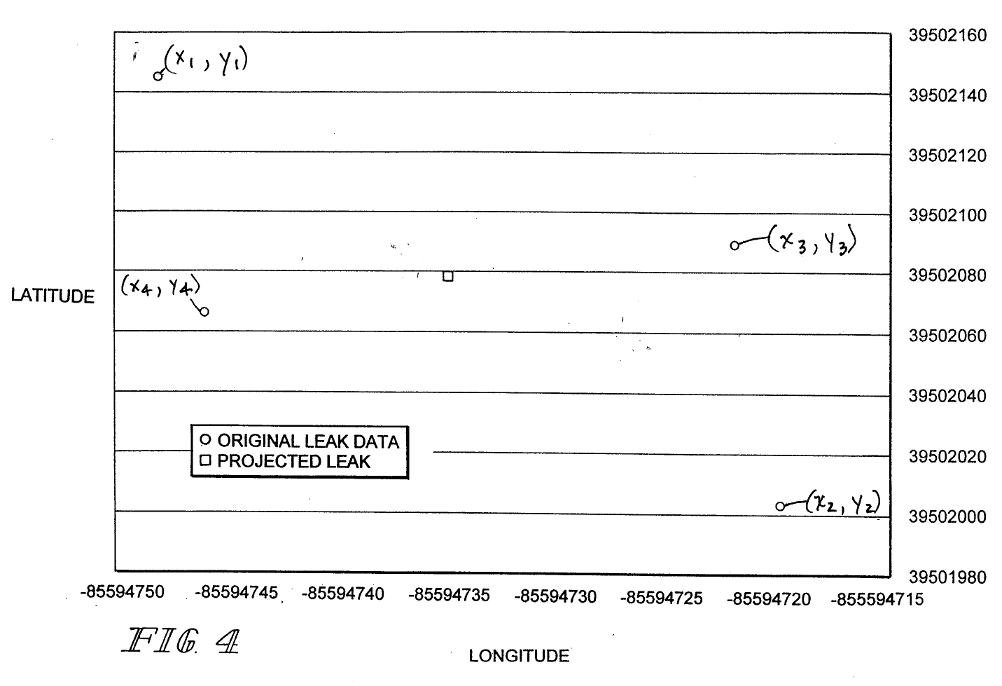

The longitudes and latitudes are normalized to coordinates which lie fairly centrally among them, in this case, −85.594735°, 39.502070°. See FIG. 4. This particular point is at about the intersection of a line drawn between (x₁, y₁) and (x₂, y₂) and a line drawn between (x₃, y₃) and (x₄, y₄). This point can also be determined by solving the simultaneous equations (y−y₁)/(x−x₁)=(y₂−y₁)/(x₂−x₁) and (y−y₃)/(x−x₃)=(y₄−y₃)/(x₄−x₃) for x and y. Normalization is performed to implement the above-discussed conversion to meters, which then yields the leakage field strength in μV/m. The calculations thus become:

z₁=(26/3)sqrt((0.000013°)²+(−0.000075°)²);

z₂=(23/3)sqrt((−0.000015°)²+(0.000067°)²);

z₃=(21/3)sqrt((−0.000013°)²+(0.000019°)²); and,

z₄=(20/3)sqrt((0.000011°)²+(0.000004°)²),

where, at this latitude and longitude, 14×10⁻⁶°˜1.55435 m and 67×10⁻⁶°≈5.76273 m at x=−85.594735° and y≈39.502070°. Picking z₁ and converting the latitude and longitude differences to meters as discussed above yields a leakage strength of about 51.7285 μV/m at the location of the leak.

FIG. 4 illustrates the projected leakage position graphically from the latitudes y₁, . . . y₄ and longitudes x₁, . . . x₄ of the four measured leakage signal strengths z₁ . . . z₄.

What is claimed is:

1. A method of determining the location of a leakage signal from a network, the method including measuring at various times and locations leakage believed to be associated with the leakage signal, constructing a data base of leakages and associated locations, selecting from the data base a number of leakage values, multiplying each of the selected leakage signal value times a locus of points on which a leakage signal associated with that respective signal strength may be assumed to reside to develop a number of relationships among leakage signal strength, leakage and location, solving a first pair of these relationships among leakage signal strength, leakage and location for a first locus of common points to the first pair, solving a second pair of these relationships among leakage signal strength, leakage and location for a second locus of common points to the second pair, projecting the first and second loci onto a common surface, and determining the intersection of the first and second loci on the common surface.

2. The method of claim 1 further including determining the strength of the leakage signal by substituting the intersection of the first and second loci on the common surface back into a selected relationship among leakage signal strength, leakage and location and solving for the strength of the leakage signal.

3. The method of claim 1 wherein solving a first pair of these relationships among leakage signal strength, leakage and location for a first locus of common points to the first pair and solving a second pair of these relationships among leakage signal strength, leakage and location for a second locus of common points to the second pair together comprise selecting a location about which the solutions are to be normalized and solving the first and second pairs of the relationships about the location about which the solutions are to be normalized.

4. The method of claim 1 wherein solving a first pair of these relationships among leakage signal strength, leakage and location for a first locus of common points to the first pair and solving a second pair of these relationships among leakage signal strength, leakage and location for a second locus of common points to the second pair, and projecting the first and second loci onto a common surface together comprise converting an angular distance into a linear distance.

5. The method of claim 4 wherein converting an angular distance into a linear distance comprises using a table to convert an angular distance into a linear distance.

6. The method of claim 4 wherein converting an angular distance into a linear distance comprises calculating a linear distance from an angular distance.

7. A method of determining the amplitude of a leakage signal from a network, the method including measuring at various times and locations leakage believed to be associated with the leakage signal, constructing a data base of leakages and associated locations, selecting from the data base a number of leakage values, multiplying each of the selected leakage signal value times a locus of points on which a leakage signal associated with that respective signal strength may be assumed to reside to develop a number of relationships among leakage signal strength, leakage and location, solving a first pair of these relationships among leakage signal strength, leakage and location for a first locus of common points to the first pair, solving a second pair of these relationships among leakage signal strength, leakage and location for a second locus of common points to the second pair, projecting the first and second loci onto a common surface, and determining the intersection of the first and second loci on the common surface.

8. The method of claim 7 further including determining the strength of the leakage signal by substituting the intersection of the first and second loci on the common surface back into a selected relationship among leakage signal strength, leakage and location and solving for the strength of the leakage signal.

9. The method of claim 7 wherein solving a first pair of these relationships among leakage signal strength, leakage and location for a first locus of common points to the first pair and solving a second pair of these relationships among leakage signal strength, leakage and location for a second locus of common points to the second pair together comprise selecting a location about which the solutions are to be normalized and solving the first and second pairs of the relationships about the location about which the solutions are to be normalized.

10. The method of claim 7 wherein solving a first pair of these relationships among leakage signal strength, leakage and location for a first locus of common points to the first pair and solving a second pair of these relationships among leakage signal strength, leakage and location for a second locus of common points to the second pair, and projecting the first and second loci onto a common surface together comprise converting an angular distance into a linear distance.

11. The method of claim 10 wherein converting an angular distance into a linear distance comprises using a table to convert an angular distance into a linear distance.

12. The method of claim 10 wherein converting an angular distance into a linear distance comprises calculating a linear distance from an angular distance.
